(19) United States
(12) Patent Application Publication
(10) Pub. No.: US 2007/0088740 A1
(43) Pub. Date: Apr. 19, 2007

(54) Information system development

(76) Inventors: James Davies, Oxford (GB); Edward Crichton, Oxford (GB); Ib Holm Sorensen, Oxon (GB); David Neilson, London (GB)

Correspondence Address: WADDEY & PATTERSON, P.C., 1600 DIVISION STREET, SUITE 500, NASHVILLE, TN, 37203, US

(21) Appl. No.: 10/570,381

(22) PCT Filed: Aug. 24, 2004
(86) PCT No.: PCT/GB04/03613

§ 371 Date: Nov. 1, 2006

(30) Foreign Application Priority Data
Sep. 1, 2003 (GB) 0320468.2

(51) Int. Cl. G06F 17/00

(52) U.S. Cl. 707/103 R

(57) ABSTRACT

A method or apparatus for use in generating an information system, wherein an object-oriented model of the information system is provided, the model defining classes of information objects require to be supported by the information system in terms of their attributes, operations that maybe performed on the object, and an intended relationship (if any) between two or more of the objects. Built-in or predefined descriptions of the operations which maybe performed on the objects are provided in terms of conditions that should hold initially, data that might be affected, and the desired results. An operation referenced in a class definition is then automatically expanded by adding a respective built-in or predefined description thereto within the object-oriented model of the information system. It is determined if the attributes of any other class defined within the model would be affected by the operation and, if so, the operation is automatically further expanded to include an update function to update one or more attributes determined to be affected by the operation accordingly.

This invention relates generally to information system development and, more particularly, to a method and apparatus for generation of an information system such as a database or the like.

The promises of the information technology revolution—the paperless office, instant, electronic assistance, access and control independent of location—have been only partially realised. Until recently, this could be explained in terms of the relative inaccuracy of the hardware used for computing and communication. Now, however, it tends to be the software that is holding this area of technology back.

There are two respects in which software may fail to meet requirements, namely it may be unreliable (or it may not work at all), or it may work perfectly well, but what it does, or the way that it does it, does not really meet the user's requirements. In either case, promises are broken; in some respect, whether it be quality, efficiency or functionality, the system falls short of the user's expectations.

To improve reliability, more care needs to be taken over software development. It may even be necessary to produce a formal specification, agree with all parties that this represents the requirements, and then demonstrate that the proposed implementation is a suitable refinement, i.e. its every behaviour can be guaranteed to match the specification.

However, taking care takes time, and the slower the rate of development, the harder it is to create software that meets the users' requirements. Most users do not have a precise description of the business processes that the software is intended to support; and, even if they do, these processes will change with time.

The only way to match, or even properly identify, requirements in accordance with the prior art, is to produce something quickly, and use this as a basis for further discussion. Various approaches have been proposed, but developers are still faced with a choice between:
quick solutions that are well-matched to the requirements, but may prove unstable, unreliable or unscalable, and thus, perhaps, unusable;
slow solutions that are stable, reliable, and scalable, but may be a poor match for the final requirements—at least by the time they are delivered.

The various activities which are undertaken when developing information systems and software are commonly modelled as a software development lifecycle. The software development lifecycle begins with the identification of a requirement for software and ends with the formal verification of the developed software against that requirement.

The software development lifecycle does not exist by itself, it is in fact part of an overall product lifecycle. Within the product lifecycle, software will undergo maintenance to correct errors and to comply with changes to requirements. The simplest overall form is where the product is just software, but it can become much more complicated, with multiple software developments each forming part of an overall system to comprise a product.

There are a number of different models for software development lifecycles. For example, a conventional Waterfall Lifecycle Model is illustrated in FIG. 1 of the drawings. As shown, this model comprises a set of sequential pre-defined phases consisting of:
1. The Requirements phase, in which the requirements for the software are gathered and analysed, to produce a complete and unambiguous specification of what the software is required to do.
2. The Architectural Design phase, where a software architecture for the implementation of the requirements is designed and specified, identifying the components within the software and the relationships between the components.
3. The Detailed Design phase, where the detailed implementation of each component is specified.
4. The Code and Unit Test phase, in which each component of the software is coded and tested to verify that it faithfully implements the detailed design.
5. The Software Integration phase, in which progressively larger groups of tested software components are integrated and tested until the software works as a whole.
6. The System Integration phase, in which the software is integrated to the overall product and tested.
7. The Acceptance Testing phase, where tests are applied and witnessed to validate that the software faithfully implements the specified requirements.
8. The Maintenance phase (not shown), in which errors are corrected and changes to requirements are complied with.

However, because requirements are likely to keep changing throughout the development process, it is often necessary to keep “jumping back” from a later phase to one or more earlier phases to comply with the requirement changes. In other words, during the software development process, there may be several versions of the software before the final version is reached. The soft ware produced by an early stage of the process may never actually be used, it may simply serve as the prototype. A prototype will take short cuts in order to provide a quick means of validating key requirements and verifying critical areas of design. These short cuts may be in areas such as reduced documentation and testing.

The various phases of the development process are tend to be performed by different people or departments, such that when it is necessary to keep “jumping back” through the design model, it can be difficult to ensure that the software already developed is updated correctly in response to a change. Furthermore, when a new version of the software is produced, data entered into the earlier version must be re-entered, which is time-consuming and subject to errors.

We have now devised an improved arrangement.

In accordance with a first aspect of the present invention, there is provided a method for use in generating an information system, the method comprising the steps of:
a) providing an object-oriented model of said information system defining classes of information objects required to be supported by said information system in terms of their attributes, operations that may be performed on said objects, and an intended relationship (if any) between two or more of said objects;
b) providing built-in or predefined descriptions of operations which may be performed on said objects, in terms of conditions that should hold initially, data that might be affected, and the desired results;
c) automatically expanding an operation referenced in a class definition by adding a respective built-in or predefined description thereto within said object-oriented model of said information system;
d) determining if the attributes of any other class defined within said model would be affected by said operation and, if so: p0 e) automatically further expanding said operation to include an update function to update one or more attributes determined to be affected by said operation accordingly.

Also in accordance with the first aspect of the present invention, there is provided apparatus for use in generating an information system, the apparatus comprising:
a) means for providing an object-oriented model of said information system defining classes of information objects required to be supported by said information system in terms of their attributes, operations that may be performed on said objects, and an intended relationship (if any) between two or more of said objects;
b) means for providing built-in or predefined descriptions of operations which may be performed on said objects, in terms of conditions that should hold initially, data that might be affected, and the desired results;
c) means for automatically expanding an operation referenced in a class definition by adding a respective built-in or predefined description thereto within said object-oriented model of said information system;
d) means for determining if the attributes of any other class defined within said model would be affected by said operation and, if so, automatically further expanding said operation to include an update function to update one or more attributes determined to be affected by said operation accordingly.

Thus, the first aspect of the present invention operates to automatically update all affected attributes in the model when a change (in the form of a new operation) is introduced. This clearly increases the speed of generation of the information system, reduces processing and personnel requirements for progressive development of the system, avoids duplication of effort and ensures that the software code is streamlined and efficient, thereby minimising memory capacity requirements.

In a preferred embodiment, the attributes are declared in the object-oriented model of the information system as elements of a particular type. Preferably, an additional feature is defined in respect of the attributes and classes, the additional feature comprising a dimension which is the expected average length of a string or the cardinality of a set. In a preferred embodiment, a user is able to define enumerated types and/or type synonyms.

Beneficially, one or more of the attributes maybe of object type which describe references to objects in the same environment. Beneficially, links are provided between two or more of the references, the links implementing relationships between respective references. Relationships implemented by the links may be one-to-one, one-to-many, many-to-one or many-to-many.

In a preferred embodiment, the behaviour of a particular class of object is described by a collection of method definitions. These method definitions may be classed in terms of operations which are to be accessible to a user and operations which are only to be used in the definition of other methods. A method may be defined in the context of a particular attribute. A method may be described in an abstract manner in terms of properties.

In one exemplary embodiment, every method or operation is defined as a combination of two properties, a precondition and postcondition, together with a list of attributes whose values might change. Beneficially, if an attribute is included in the list but not in the postcondition, the attribute will appear as a input to the respective operation, and is assigned a default postcondition specifying that the value of such an attribute after said operation will be equal to the value of the input provided.

One or more of the attributes may point to a data item stored on a server which may be separate from or integral with the apparatus. The apparatus may further include means for performing any of the steps or implementing any of the features of a method as defined above.

In accordance with a second aspect of the present invention, there is provided apparatus for use in generating an information system, the apparatus comprising:
a) means for generating a first object-oriented model of said information system;
b) means for generating a second object-oriented model of said information system;
c) means for comparing said first and second models and identifying any differences therebetween; and
d) means for automatically generating only the objects which have changed between said first and second models.

In a preferred embodiment, the apparatus further includes means for automatically upgrading any test data used in said first model to reflect changes made between said first and second models, such that said test data is in a correct form for use in said second model.

Also in accordance with the second aspect of the present invention, there is provided a method for use in generating an information system, the method comprising the steps of:
a) generating a first object-oriented model of said information system;
b) generating a second object-oriented model of said information system;
c) comparing said first and second models and identifying any differences therebetween; and
d) automatically generating only the objects which have changed between said first and second models.

In a preferred embodiment, the method further includes the step of automatically upgrading any test data used in said first model to reflect changes made between said first and second models, such that said test data is in a correct form for use in said second model.

As a result of the second aspect of the present invention, generation time for each successive model is kept to a minimum, as is the processing capacity required, and the automatic data upgrade means that the same data can be used and added to in each successive model such that it makes it reasonable to use the prototype as the live system during development, because data entered during testing is not lost when next version is released. This permits a novel method of development which has not previously been possible.

The apparatus of the second aspect of the present invention may include apparatus according to the first aspect of the present invention. Similarly, the method of the second aspect of the present invention may include the steps of features of a method according to the first aspect of the present invention.

As set out above, in accordance with the prior art, the developer must make a choice between a quick solution or a slow solution in an attempt to meet the user's requirements. However, in accordance with the invention, this choice is unnecessary, as it enables quick solutions that are stable, reliable and scalable. What is more, these solutions can be arranged to come with a formal specification and a guarantee of refinement, as will be explained in more detail below.

An embodiment of the present invention will now be described by way of example only and with reference to the accompanying drawings, in which:

FIG. 1 is a schematic block diagram illustrating the various phases of a Waterfall Lifecycle Model;

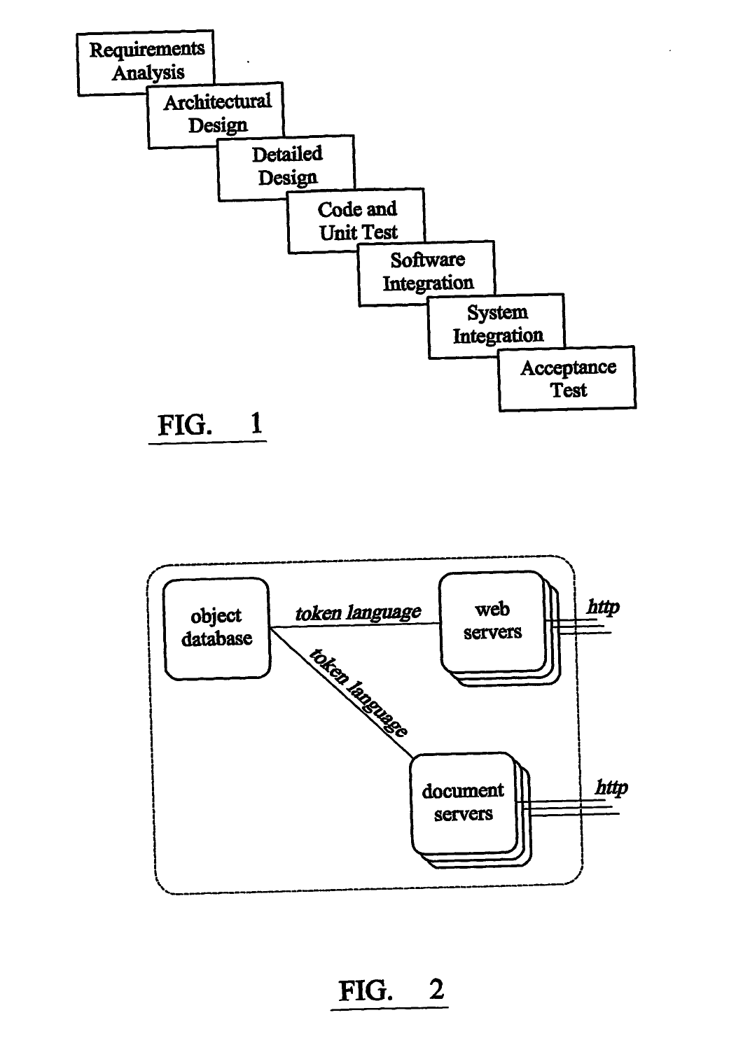

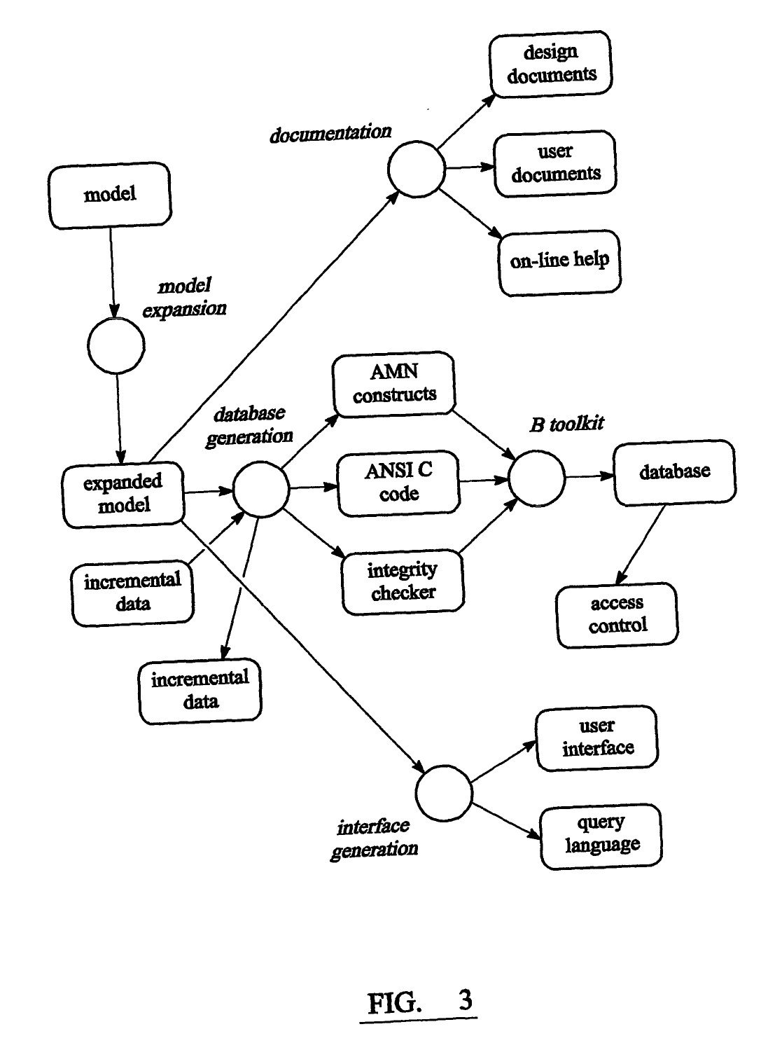

FIG. 2 is a schematic block diagram illustrating an architecture for use in apparatus according to an exemplary embodiment of the present invention;

FIG. 3 is a schematic block diagram illustrating a complete information system generation system according to an exemplary embodiment of the present invention;

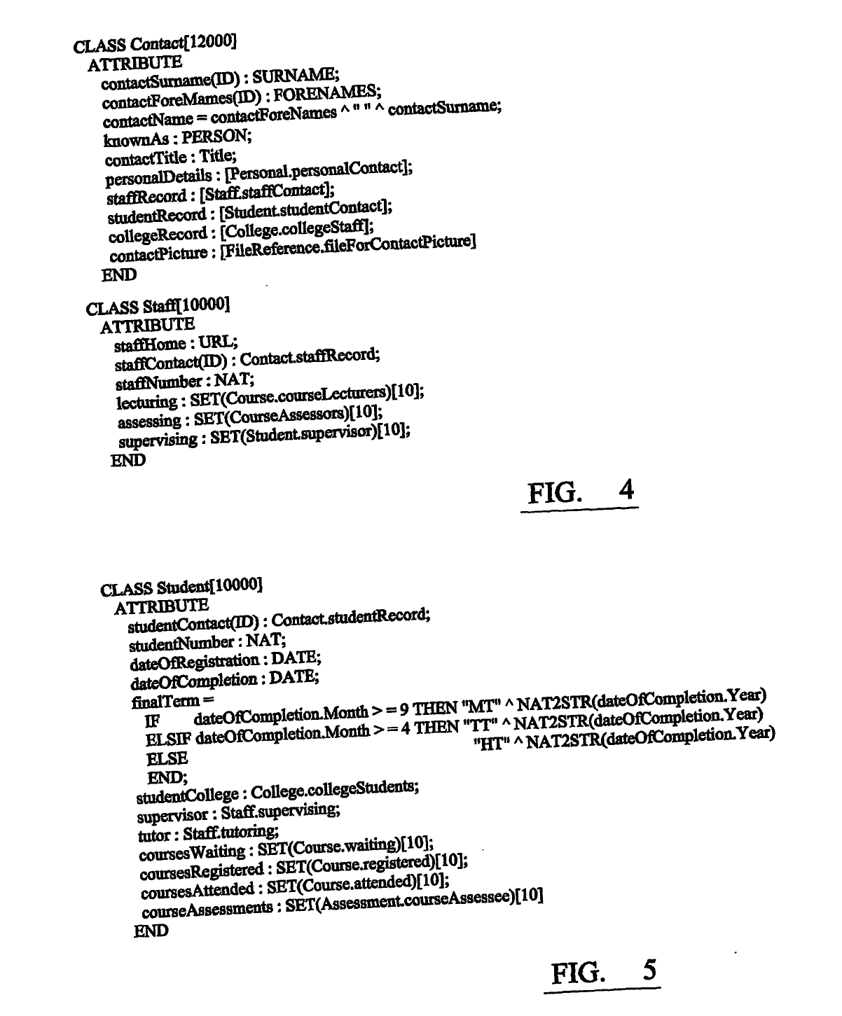

FIGS. 4, 5 and 6 are exemplary class definitions for Contact and Staff objects, Student objects and FileReference objects respectively;

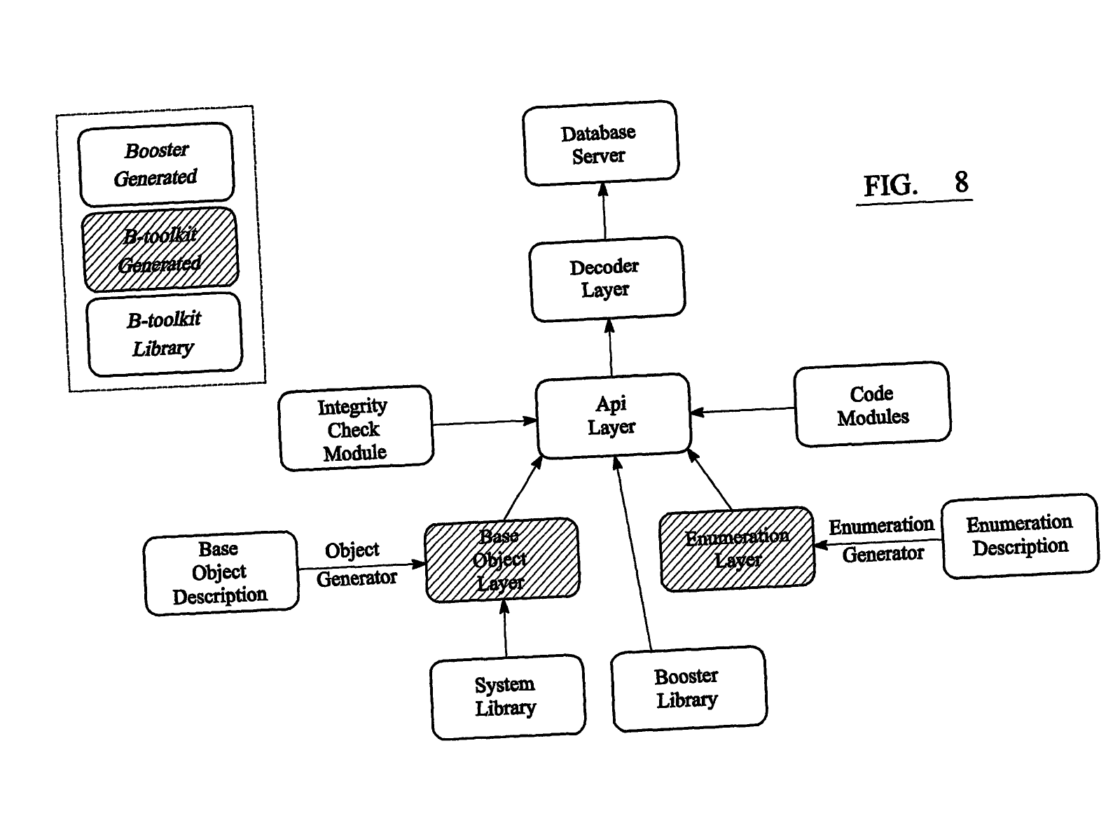

FIG. 7 is a schematic block diagram illustrating a process for database generation according to an exemplary embodiment of the present invention;

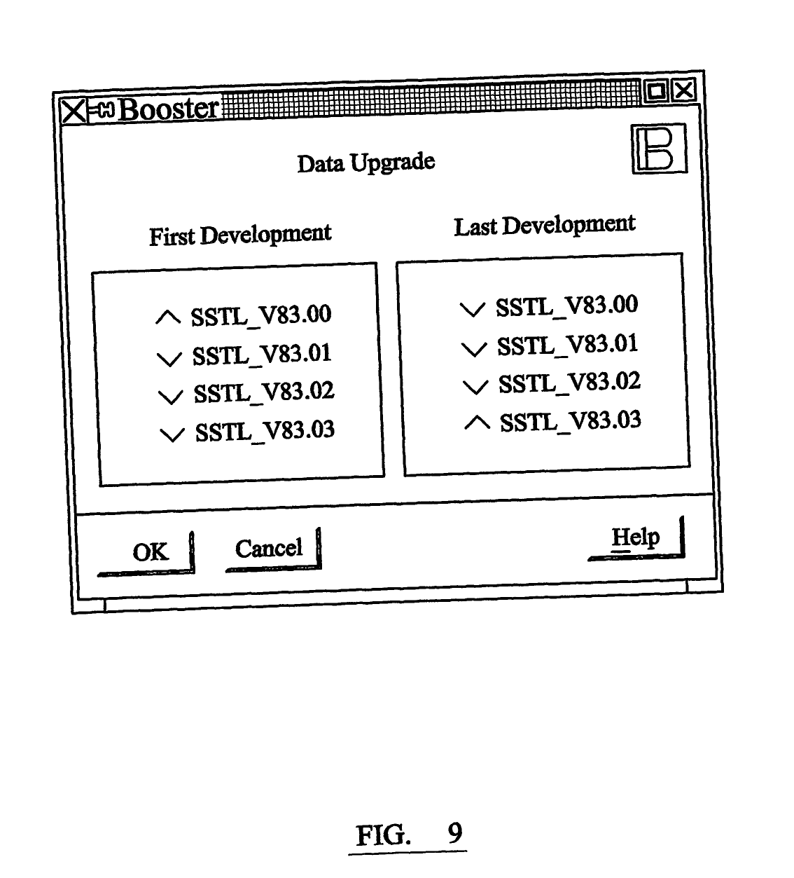

FIG. 8 is a schematic block diagram providing an overview of an AMN Construction; and

FIG. 9 illustrates the operation of Data Upgrade interface used in a system according to an exemplary embodiment of the present invention.

Referring to FIG. 2 of the drawings, the solutions produced by an exemplary embodiment of the present invention fit within a particular web-based architecture:
1. an object database;
2. a web server; and
3. a document server.

The object database stores small pieces of information and the relationships between them. The web server provides the user interface to the system, and the documents server stores larger pieces of information: text documents, program files, images, audio and video. Although the object database can be partitioned into a collection of smaller databases, to further improve performance, it will always appear to the rest of the system as a single, sequential entity. There is no limit upon the number of web or documents servers that can be used concurrently. Each of these components is platform-independent and the system is arranged to be accessible to anyone with a web browser and an internet connection.

The object database component reflects the current model of the system; it may contain objects of any class described in the model, with the corresponding features and attributes. These objects may hold small amounts of data as numbers or strings of characters, they may refer to each other using links or references, and they may point to documents stored on a document server. The object database component may be seen as a combination of seven sub-components:
1. A network component
2. A token language interpreter
3. An operation decoder
4. A method layer
5. An object layer
6. A library layer
7. A basic input/output component

The network component accepts and queues requests, passing them for sequential interpretation. The interpreter uses the operation decoder to translate the token language into calls upon database functions: the functions of the method and object layers. Note: all interaction with the database in accordance with this exemplary embodiment of the invention is conducted in a language of tokens. This is reminiscent of computer assembly language, with operators and opcodes, but with branching and a data structure in place of the expected linear program listing. The operators are fixed, but the allowed syntax of opcodes is generated to match the current model.

Every function in the method layer is constructed from the primitive functions of the object layer; these are used to set and get the values of every object attribute. The library layer provides support for primitive types, numbers and strings.

Each function has a pre-condition and a post condition, formally specified as part of the system model. Standard functions, such as ADD and DELETE, have implicit, well-understood pre-and post conditions, in addition to any added in the model itself.

There are three modes in which an operation from the model—and the database function that implements it—can be used:
test: check to see if the precondition (and any invariant property specified) is true;
test and set: carry out that check, and if it succeeds, perform the operation itself;
set: assume that the check would succeed, and perform the operation.

The first mode is used to sensitise the buttons, or construct a menu of applicable operations, for presentation to a user. The second is used when a button is pressed, or a menu item is selected: even though the operation was applicable when the current page was generated, circumstances may have changed. The third mode is used in the implementation of more complex functions, in the case where the truth of the precondition and invariant has been established and—the database having been locked in the meantime—the system is certain that it is safe to call the operation without checking again.

The post conditions are used to guide the implementation of the operation: a function is generated that will achieve the postcondition, while making a minimal change to the attribute values, and preserving any invariants. In general, the generation process would be arbitrarily hard. However, in this domain, it is entirely automatic.

Referring to FIG. 3 of the drawings, an information system generation process according to an exemplary embodiment of the present invention begins with a formal, object-oriented model of the required information system. The model defines the kinds of information objects that will be created—most of these will correspond to entities in the real world, such as people, appointments, requests, reports or invoices, for example—and the ways in which these objects may evolve and interact.

The modelling language used herein embodies concepts and descriptive techniques from three different areas of computer science:
object modelling—each kind, or class, of entity is defined in terms of the information content of objects of that class, the operations that may be performed upon objects, and the intended relationships between objects;
set theory—relationships are described completely, and precisely, in terms of sets and sequences of references to other objects;
refinement calculus—operations are described abstractly, in terms of the conditions that should hold initially, the data that might be affected, and the desired results.

These techniques are relatively familiar to persons skilled in the art.

The first stage of the process illustrated in FIG. 2 is an expansion of the model; the descriptions of the operations are completed as follows: built-in operations are added to each of the class descriptions; the effect of each class description is considered in the wider context of the entire model; operation descriptions are completed according to a principle of minimal change. The result of this procedure is an expanded version of the model, with enough detail to uniquely determine the behaviour of a distributed information system.

In the second stage, the class and operation descriptions of the expanded model are complied into the Abstract Machine Language (AML) of the B tool kit (which is a proprietary software application, developed and owned by B-Core and licensed throughout the world). The AML is then translated into ANSI C, which can then be compiled into executable code on almost any computing platform. An additional output of the generation process is an integrity checking module, which forms part of the final database code. This can be used to check that the invariant properties of the database are preserved after each operation—an additional safeguard against design errors that could not be caught during the compilation process.

The efficiency of the above-described dual compilation process is enhanced in two ways: firstly, aspects of the model can be compiled directly to C, mirroring the behaviour of the B Tool kit in this regard; secondly, only those aspects of the model whose implementation has changed since the last compilation needs to be rebuilt.

With reference to the user interface, the class description of the expanded model lists the name and type of every attribute in the database, and the name, arguments, and expected return type of every operation. It is used to generate—again automatically—a complete web-based interface to the database: any object can be viewed; any link can be followed; any operation can be called. In most cases, the resulting system will be perfectly usable without any further input in terms of interface design. To simplify the presentation:
Attributes involving local values, for example, of number or string type, are grouped together, and may be modified with a single update operation. The implementation of this operation tests to see whether values have been changed before writing the new value to the location: differences can be added to a log.
The user is presented with a choice of ‘operation’ or ‘data’ views of the remaining attributes:
   in the operation view, the user has a menu of operations, together with selection widgets for input. Where the input values are constrained by the contents of the database, the widgets can be set to offer only valid combinations.
   in the data view, the user has a list of attributes with their current values, together with a button for each of the basic operations that may be performed on them.

The web server compiles the information obtained from the model into a series of scripts for calling operations, for checking that the results have the expected structure, and for displaying information as standard web pages.

The user interface referred to above comes with its own object-oriented query language—tailored to the attributes in the database, and a report generator. This can be used to extract information as text, as navigable HTML, or, as an additional default, in a format suitable for input to standard spreadsheet or database packages.

The expanded model is also a useful source of information for the designer, who is able to examine the consequences of decisions taken in the design of different classes, in terms of their effect upon the (derived) design of operations. Effects and constraints hidden in the original model may have been made explicit by the expansion process. More important, however, is the way in which the expanded model can serve as documentation for the user. A navigable version of the class information, without the implementation details of the operations, is an ideal reference for any user who wishes to write their own queries (it could even be incorporated into the kind of conventional query wizard supplied with consumer databases). Furthermore, the specification of each operation can easily be translated into fragments of natural language, and presented to any user who wishes to know why a particular operation is shown as unavailable in the current situation. For example, the operation to move a meeting might be blocked because the meeting has already occurred: when the user moves their mouse over the (‘greyed-out’) button for the move operation, they would be presented with the information that ‘scheduled time of meeting is before current system time’. The capacity to present such information is a standard feature of the interface generated by the system according to this exemplary embodiment of the present invention. The result of the generation process is thus a user-friendly, web-based, information system whose behaviour, and documentation, is guaranteed to conform exactly to the original model. The object-oriented nature of the modelling language makes it easier to construct a system that accurately reflects user requirements. The incremental build and integrity checking features provide support for rapid prototyping, rapid development and extreme programming techniques.

With reference to the Access Controls block in FIG. 3, additional information can be entered into the database to produce customised interfaces for different classes of user.
A projection of the model can be defined, for each class of user, in terms of visibility, modifiability and clickability. Only visible attributes will be displayed, only modifiable attributes can be updated, only clickable links can be followed, and only clickable operations can be called. At the top level, a projection defines each (class of) user's entry points into the data. A projection can be defined in terms of the values of any of the attributes in the database. For example, whether the user is able to view the list of participants in a meeting might depend on whether his or her own name appears. The result is a completely general, dynamic approach to security.
Customised designs for web pages can be stored in the database, providing tailored access for certain classes of user, or a complete public web site—a shell for the database.

All of this information is automatically preserved between generations—an additional benefit of the incremental build approach described above.

The various elements of the generation process discussed briefly above, will now described in more detail.

1. Model Expansion

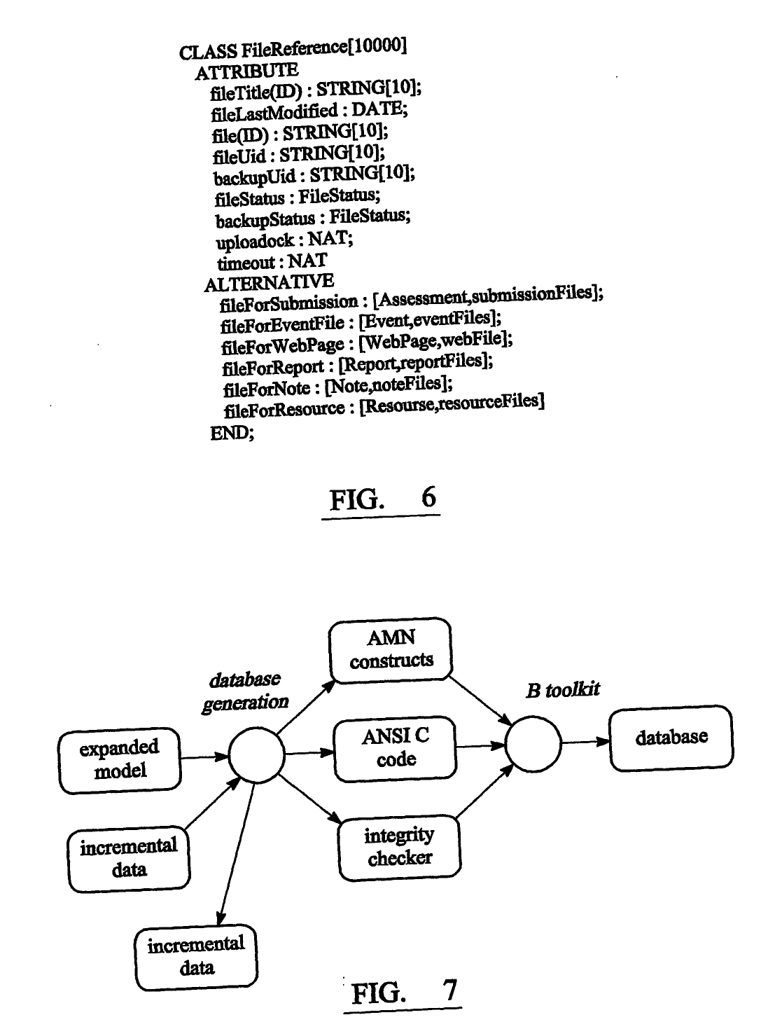

a) The modelling language
   The abstract model of the system is written in a purpose-built, object-oriented, modelling language. Although the ideas and constructs used in this language should be familiar to any software developer, their use and arrangement is different to conventional techniques.
   The database is expressed as a collection of CLASS definitions, each describing the state and behaviour of a particular type of object. Each class definition comprises a list of data attributes, each of which is declared as an element of a particular type. An additional feature of attributes, and classes, is the dimension—the expected average length of a string, or the cardinality of a set. The performance of the generated database will be optimal with respect to this expected usage.
   Several primitive types are provided: NAT, STRING, SET, and OSET. Rather than employ a set whose cardinality is limited to 0 or 1, an optional attribute may be defined using square brackets: [ ]. In addition, the user may define their own enumerated types and type synonyrns: for example, the definition
      DATE (Year, Month, Day)=NAT(4,2,2)
   introduces a type DATE, synonymous with a triple of numerical values: the first being 4 digits long, the others being 2 digits long. Projection functions are automatically generated: for example, if date is an attribute of type DATE, then the user may write date. Year to denote the value of the first component.
   Other attributes are of object type, and describe references to objects in the same environment. References may be linked in both directions: for example, in the example of FIG. 4, if the optional staff Record of a Contact is set, then (a reference to) that Contact object will be the mandatory staff Contact attribute of the Staff object. The relationships implemented by these links may be one-to-one, one-to-many, many-to-one or many-to-many.
   Attributes may point to documents stored on a separate server. An example of this is given by the contact Picture attribute of the Staff class in FIG. 4. They may also be defined in terms of other attributes: the derivation of the final Term attribute of the Student class is shown in FIG. 5. Finally, the ALTERNATIVE keyword introduces a special kind of attribute: a group of alternatives of which at most one may be set. An example of how this may be used is given in FIG. 6.
b) Methods
   The behaviour of a particular class of objects is described by a collection of method definitions, preceded by the keyword METHODS, for operations that will be accessible to the user, or the keyword LOCAL-METHODS, for operations that can be used only in the definition of other methods. This style of definition is standard practice in object-oriented design and programming, but there are two key differences: firstly, methods can be defined in the context of a particular attribute, rather than simply within the context of the class; secondly, methods are described abstractly, in terms of properties.
   Every method, or operation, is defined as a combination of two properties, together with a list of attributes whose values might change. The first property, the precondition, describes the situations in which the operation is designed to be used; the second, the post condition, describes the intended result.
      precondition|change variable list:post condition
   The change variable list defines the extent of the operation; only items in this list are allowed to change. This mode of description is a variation upon the style adopted for the refinement calculus, a development of Hoare triples and weakest preconditions—notations that should be familiar to any theoretical computer scientist.
   While the notation is familiar, key aspects of its interpretation are not. For example, if an attribute is mentioned in the change list but not in the post condition, then it will appear as an input to the operation, and it will be assigned a default, generated post condition:
      variable=variable_in
   that is, the value of such an attribute after the operation will be equal to the value of the input provided.
   Furthermore, if the post condition requires the removal of a reference, then the absence of the target object from the change list indicates the simple removal of the reference, and of the corresponding reference in the opposite direction. The inclusion of the target object in the change list indicates not only the removal of the reference, but also the removal of the target object itself.
   Several basic operations are provided: Create, and Kill for objects; Add and Delete for references in a collection; New and Remove for the actual objects referenced in a collection.

Update for combinations of scalar attributes; Set and Clear for attributes; Up, Down and Position for references in sequence. All of these can be extended by strengthening their default pre- or post-conditions.
c) The Expansion Process
   The definition of each operation in the model is expanded by: adding suitably-instantiated copies of the built-in-pre-and post-conditions for that kind of operation. For the purposes of expansion, the kind of operation is determined by the operation name, and—if the definition is in the context of a particular attribute—the type of attribute being operated upon. Input attributes are declared, and added to the change list, as described above.
   The attributes mentioned in the definition of the operation are then examined, and links to other objects are followed. Additional properties may then be added to the pre- or post-condition of the operation definition. Furthermore, if an operation involves removing an element from a set, or deleting an object, then the precondition may be declared too weak: in this case, the intention of the designer is not clear, and the generator will signal an error, requiring that the intention be clarified.

As an example of the expansion process, consider the results of expanding the definition of Add below:

```
CLASS Car [100]
  ATTRIBUTE
    availableColours : SET (colour) [25]
      METHODS
        Add
```

Whenever an operation named Add is defined upon a set-valued attribute, default pre- and post-conditions are added to the expanded version: this is a built-in basic operation upon attributes of set type. The default precondition is that the object to be added is of an appropriate type, and that it is not already in the set. The default postcondition is that the object should be in the set.

No change list has been defined, which means that a minimal change list will be constructed on the basis of the expanded postcondition. This comprises the current object and a new, input attribute, with name availableColours_in. At this point, the expanded method looks like this:

```
METHODS
  Add(
    Car_this : Car &
    availableColours_in :  Colour &
    availableColours_in / :  Car_this. availableColours
    |
      availableColours
      :
      (availableColours_in : Car_this. availableColours)
)
```

An attribute such as availableColours may be linked to a set-valued attribute in the target class, as in the following:

```
CLASS Car [100]
  ATTRIBUTE
    availableColours : SET (Colour.carColours) [25]
      METHODS
        Add
...
CLASS Colour [50]
  ATTRIBUTE
    carColours : SET (Car.availableColours) [10]
```

then the carColours attribute of the other object may be added to the set of colours used for this particular kind of car: that is, the current car object must be added to the linked set. The resulting expanded method is

```
METHODS
  Add (
    Car_this : Car &
      availableColours_in : Colour &
      availableColours_in / : Car_this.availableColours
|
      availableColours, carColours
      :
      (availableColours_in : Car_this, availableColours &
        Car_this : availableColours_this. carColours
)
```

2. Database Generation

The generator takes the expanded model, together with the incremental data produced in previous builds, and generates a collection of AMN constructs, together with some ANSI C source code, and the source code for a complementary integrity checking module. This code is then integrated and compiled by the B toolkit. This stage of the generation process is emphasised in FIG. 7.
a) AMN Constructs
   The postconditions are used to guide the implementation of the operation. An AMN (Abstract Machine Notation) function is generated that will achieve the postcondition, using the following three heuristics:
      1. all data invariants (expressed as links between attributes) should be preserved
      2. the changes in attributes values should be minimal
      3. the number of objects should be minimised (so that removal of a link should remove the linked where allowed)
   The generation process would require an arbitrary degree of manual intervention; with these heuristics—along with the default descriptions of basic operations, and the interpretation of the change list—it is entirely automatic.
   AMN specifications, implementations, base object generator input designs, and enumeration designs, are produced for direct entry into the B toolkit. The design of the generator ensures that these constructs will be processed without error by the toolkit, so that that second stage of the build is entirely automatic—right through to the construction of the final code module and the packaging of all necessary files into a single, compressed archive ready for unpacking on the target platform.
b) ANSI C Source Code
   For reasons of efficiency, ANSI C source code is produced—in place of AMN constructs—for some modules. This is done only where there is no need to inspect the generated code: AMN remains accessible; any inspection of the C source code would be difficult and laborious.
c) Integrity Checker
   The links between attributes provide a natural integrity check for the database A self-contained checking module is produced by the generator, and incorporated by the B toolkit during the building process. Data integrity checking can be carried out at Various intervals, or whenever the data is modified. The integrity checking module is also used in the upgrade of data.
   In the unlikely event of an error—which could be caused only by an uncaught error in the description of one of the operations in the model, or an error in the generator itself—the database enters an integrity error state, blocking further modification—but not access—until the problem has been addressed.
   If an error occurs, an archive is immediately created pinpointing the exact nature of the error and identifying the offending objects and attributes. A roll-back operation is also enabled, allowing any user with maintenance privileges to return the system to the state before the integrity error occurred. Thus no data is lost, and the before the integrity error occurred. Thus no data is lost, and the entire system continues without any break in execution.
d) The B toolkit
   The B toolkit is the core product of B-Core (UK) Limited. It has been in existence for fifteen years, commercially available for over a decade, and is currently used world-wide. Its role is fundamental to the generation process. The version of the toolkit used is an extension of the commercially-available product, performing additional, specific tasks such as the recompilation of generated code and the final packaging of constructs for the target platform.
   In particular, the system library layer has been extended with specific modules for direct inclusion in the API layer (see Section): one example is the module that is used to generate user names and passwords. Also, the library constructs used in building the Base Object Layer have been stripped—there is no redundant code in the final executable.
   There are three types of output produced by the database generator: AMN constructs, ANSI C code modules and the integrity checking module. Once database generation is complete, the toolkit automatically updates with the changed constructs and remakes the entire development, culminating in the production of an archive for the target platform.
   AMN software is usually built in layers; this approach is used extensively in the generated systems: there maybe as many as 20 layers in a typical generated database. However, the most important layers are the base object layer, the API layer (for Applications Programming Interface) and the decoder layer (see FIG. 8).
e) The Base Object Layer
   In order to produce the base object description, the generator has merely to divide the expanded model into single classes, strip out the operation definitions, and carry out some simple modifications upon the syntax. The B toolkit will then be able to generate a specification/implementation pair for each class, together with a set of re-usable abstract machines, which provide basic abstract data types encapsulating basic state and data structures.
   The generated specifications are guaranteed to be internally consistent, and the implementations are guaranteed to meet their specification—these modules are thus available in the design of the API Layer. The toolkit library layer provides support for primitive types, numbers and strings, and persistent data.

As an example, consider the following generated specification, which describes the operation of retrieving the courseSubject value of a Course object:

```
Elem_SUBJECTOBJ <-- val_courseSubject(Base_Course) =
  PRE Base_Course : Course THEN
    Elem_SUBJECTOBJ : = courseSubject(Base_Course)
END
```

f) The API Layer
   The API layer consists of three separate sub-layers. The first corresponds exactly to the METHODS of the expanded model; these are the operations that will appear of the web interace. The second corresponds to the LOCAL_METHODS. The third is an artifact of the use of the B toolkit—it is there to provide support for formal proofs of correctness, should these be required.
   Here the goal of the generator is to build, for each object, a specification mirroring the expanded methods for that object, and then to construct a design which faithfully implements each specification. The target software layer for the design is that of the base object produced by the toolkit's object generator.
   It is an important feature of a formal development that the designer of a particular software layer needs to know only the details of the specification of the layer on which they are implementing—the design of that layer being the responsibility or someone else. So the generator needs to know only the specifications of the base object layer; it uses these operations as its instruction set for building a design.

For example, a fragment of code using the base-generated operation val_courseSubject shown above to determine whether or not the Course. courseAssessors set currently contains that subject:

```
IF rr = TRUE THEN
  VAR courseSubject_obj, ii IN
      courseSubject_obj <-- val_courseSubject (Course_obj);
    rr, ii <-- within_subjectAssessors (courseSubject_obj,
    courseAssessors_obj
  END
END
```

Although a formal proof of correctness may not be required, each AMN construct is subjected to rigorous checking by the B toolkit's static analyser. Further checks are carried out before the AMN is translated by the toolkit into ANSI C source code—ready for compilation and subsequent linking to produce the database server executable.
These top-level AOI operations may be called by the Decoder in three different ways:
   1. To determine whether an operation is currently applicable
   2. To provide input lists for modify operations
   3. To modify data
and each of these is described in detail below, in Section ??
The lower-level API operations are called only be the top-level API (they therefore play no part in the construction of the web interface), and these operations may be called in two ways:
1. To determine whether its precondition is true.
   This corresponds to cases 1. and 2. above when the call may be propagated through the lower-level API layers.
2. To establish the postcondition
   This corresponds to case 3. above.
A distinction between the calling of the top-level API and lower-level API operations is that although the latter may be called to establish the postcondition without checking the precondition (for reasons of efficiency) by virtue of it being a subroutine call from the top layer, this is not so for the top layer: even though a precondition check may returned true (so that, for example, a button on the interface could be shown as being applicable) by the time the button is pressed circumstances may have changed so it will be necessary to again check that the precondition still holds before proceeding to establish the postcondition.
g) The Decoder Layer
Requests from the interface are processed by the decoder component of the database. The decoder consists in four different subsidiary layers: a control layer, an interpretation layer, a main decoder layer, and a sub-decoder layer. The first of these determines whether the request is for data, or for the performance of an operation; the second interprets the request itself. Once interpreted, a request is passed to an appropriate (main) decoder; it will then be handled by a sub-decoder specific to the chosen data, or operation.
The format of a request is given by the following grammar:
   Request::=APR N Operation [Operation]*
where OPR is a 1-byte marker indicating that a number of API operation codes will follow, and N is a 2 byte number in the range 1 to 65535, and
   Operation::=Op_opcode N [Arg]*
where Op_opcode is a code that correspond to an operation provided by the defined API—this includes all the methods specified in the model, and the special operations for controlling and monitoring the database. Here N denotes the number of arguments to the operation.
An argument consists of either a token or a string. A token can be any 4-byte number—a natural number, a value given to an enumerated set, or a unique internal identifier (a reference). Comprises a
   Arg:=TOK 4 byte|STR string
The first two bytes of a string denote its length; these are followed by a string of byte ASCII character codes, terminated by code 0.
The response format for methods without output is given by:
   Response::=VER Version ACK
      VER Version ERR Error
where VER, ACK, and ERR are. 1-byte markers, Version is the 4-byte version number of the database build, and Error is a 1-byte error code.
The response format for methods with output is:
   Response::=VER Version RES N [Result]*|
      VER Version ERR Error
   Result::=STR string|TOK 4 byte|FIL filename STR filedata
where filename and filedata and strings.
The interpreter layer can ensure that a checkpoint is taken before any of operation is executed. If only a single operation is requested—OPR 1, then main decoder layer is called exactly once. If the operation is successful, then the system guarantees that a checkpoint will be taken before the next update request is processed. Subdecoders read in the arguments needed, and make the necessary call to the API layer.
If a request involves multiple operations—OPR N, where|verb|N>1|—then each operation is checked for successful completion. If any should fail, or if the consistency of the data is compromised during execution, then the database is restored to the checkpoint taken before the request was processed. If all of the operations complete successfully, then it is guaranteed that a checkpoint will be taken before the next update request is processed.
i) Record Retrieval Requests
Record Retrieval Format
Requests:: REC N1 Object Att_Rec [Att_Val]*
REC is a 1 byte marker which indicates that a Record of attribute values are being requested is a 2 byte number in the range 1 to 65535 indicating how many attribute values will be in the Record.
   Object::=TOK 4 byte|OPR keysearch-op N [Arg]*
TOK and OPR are 1 byte markers. 4 byte is an internal unique identifier of an object. Keysearch-op is an opcode of a Method which given a mandatory attribute value will locate an object N is a 2 byte number.
   Arg::=TOK 4 byte|sTR string
   Response Format
   Response::=VER Version REC N1
On receiving a request (REC N1 . . . ) for a Record a result buffer is being allocated with the initial contents VER Version RES N1. The contents which will follow is determined by the details of the actual Attribute Record requested (Attribute_Val), and will be written into the buffer before the buffer is sent as a reply to the Client Server.
ii) Attribute Retrieval
Attribute Retrieval are the simplest form for retrieval and provide the mechanism for getting:
   a) simple attributes: String, Number, and Enumerated Value attributes of an Objects
   b) reachable attributes: an attribute which can be reached through a chain of one-to-one Objects associations (e.g. if Object 2 is related to Object 1 through ‘attA’, and Object 3 is related to Object 2 through ‘attB’: and attC is a simple attribute of Object 3, the ‘reachable attributes value’ of Object 1 one which we normally would denote by ‘atta.attB.AttC’ can be retrieved for Object 1)
   c) Unique identifiers of Objects
Attribute Retrieval Format
Attribute_Val::=ATT N1 Attribute_opcode [OPC Attribute_opcode]*
ATT and OPC and a 1 byte marker. N1 is a 2 byte number in the range 1 to 65535.
An attribute opcode correspond to an inbuilt retrieval method. All Number attribute and intermediate Object identifiers are retrieved using a collection of retrieval methods named ‘att’_val and string attributes are retrieved using methods named ‘att’_xtr. The corresponding operation code values (‘att’_val_OP and ‘att’_xtr_op) are defined by the Decoder and used in the Client-servers generator tables.)
   Response::=TOK 4 byte|STR string
Attribute Retrieval Handling
The Decoder will when encountering an Attribute Retrieval Request access the data-base to retrieve any Intermediate Object Identifiers, and the final data will when retrieved be inserted into the buffer as a 4 byte Token or a BOOSTER string. The mechanism for Attribute interpretation uses a stack to accommodate recursive retrieval.
iii) Iterative Retrieval
Iterative Retrieval Format
   Attribute_val::=MAP objectCollectionValue Request
      MAP ListValue Request
where MAP is a 1 byte marker ListValue is one of the opcodes that are given to database operation that enable the retrieval of the actual sets which correspond to a Set attribute of an Object (SET and OSET from the Method Description) objectCollectionValue is one of the opcodes that are given to database operation that enable the retrieval of the entire collection of object belonging to aparticular Object Class. Requests are explained in 1.3
Response Format
   Response::=RES N RESK . . . RES K
Where N is 2 byte giving the size of the set or collection, K is the number of attribute requested for each element in the set. . . . will depend on the details in the Request.
Iterative Retrieval Handling
The Interpreter inquire the database to get the size of the set or collection, that value is output, and also stacked on an Iteration Control stack. The Unique Object Identifier of element with the ordinal number corresponding to the top of the Iteration Control stack is retrieved from the database and put onto the Objects stack. The remaining Request is then possessed for this Object, and when completed the top of the Iteration stack is decremented, and the next object in the set or collection is processed. This continues until the element with ordinal number 1 has been processed, at which point the Iteration Stack is pop-ed. This use of a stack facilitated recursive retrieval.
Iterative Retrieval Usage
When the Client-server present the ‘set’ attributes of an Object it uses a
   MAP set_OP REC N ATT . . . ATT
Iterative Retrieval Request where the N is the number of attributes which make up the Identification Label of the element in the set. When a Method require an Object input a
   MAP collection_OP REC N ATT . . .
ATT′ is used to produce a pull-down list so the end used can choose in the unique object identifier by means of the objects Identifying Label.
iv) Conditional Iterative Retrieval
Conditional Iterative Retrieval Format
   Att_Val::=FMAP ObjectCollectionValue Filters Request
      FMAP ListValue Filters Request
FMAP is a 1 byte Marker ObjectCollectionValue, ListValue and Request are explained above.
Filters are the internal representation of general conditions which canbe imposed on the values stored in the database. The internal form of such conditions are in disjunctive normal form: a list of disjuncts of conjuncts, a conjunct being a list of predicates which either is a boolean function defined by the API or a comparison between 2 values, one or both being values stored in the database. Details of the syntax is:

$$Filter :: = Disjunct\_EXP$$

$$Disjunct\_EXP :: = DIS N 1 {Conjunct\_EXP [ Conjunct\_EXP ]}^{*}$$

$$Conjunct\_EXP :: = CNJ N 1 {Predicate\_EXP [ Predicate\_EXP ]}^{*}$$

$$\begin{matrix}Predicate\_EXP :: = \\ \\ \end{matrix} \begin{matrix}OPC bool\_query \_opcode \vert \\ NOPC bool\_query \_opcode \vert \\ ComparisonOp Aperand Operand\end{matrix}$$
The comparisons can be between: 4 byte numbers, enumerated values, unique identifiers of objects, Booster strings or Booster dates.

$$\begin{matrix}ComparisonOp :: = \\ \\ \end{matrix} \begin{matrix}NumbersComparisons \vert \\ StringComparisons \vert \\ DateComparisons\end{matrix}$$
The codes for number comparisons are used to represent
   >, <=, <, >=, =, /=
NumberComparisons::=GTR_OP|LEQ_OP|SMR_OP|GEQ_OP|EQL_OP|NEQ_OP
The codes for strings present the lexiographical orderings
>, <=, <, >=, =, /=
substring (>:) and its negation,
prefix (<:) and its negation,
postfix (:>) and its negation

$$\begin{matrix}StringComparison :: = & GTRS\_OP \vert LEQS\_OP \vert SMRS\_OP \vert GEQS\_OP \vert \\ & EQL\_OP \vert SUBS\_OP \vert NSUBS\_OP \vert PFXS\_OP \vert \\ & NPFXS\_OP \vert PSXS\_OP \vert NPSXS\_OP\end{matrix}$$
The codes for date comparisons include a ‘within-period’ Operator and its negation.
This operator is used to determine whether a date, e.g. 14 Dec. 2002, is within a particular month (December 2002) or a particular Year (e.g. 2002)
   DateComparisons::=IND_OP|NOTIND_OP
The operand can either denote an attribute related to the object to which the filter applies, it can be a literal value, or an attribute related specific Token Object

$$\begin{matrix}Operand :: = & ATT N 1 {Attribute\_op [ OPC Attribute\_op ]}^{*} \vert \\ & TOK 4 byte \vert \\ & STR string \vert \\ & TAT N 1 {object [ OPC Attribute\_op ]}^{*}\end{matrix}$$
Response Format
   Response::=RES N RES K . . . RES K
Where N is 2 byte giving the size of the sub-set or the sub-collection whose element all satisfy the Filtering Condition K is the number of attribute requested for each element in the set . . . will depend on the details in the Request.
The interpreter inquires the database to get the sizes of the set or collection, and stack this number on an Iteration Control stack. The Unique Object Identifier of element with the ordinal number corresponding to the top of the Iteration Control stack is retrieved from the database and put onto the Objects stack. The Filtering condition is then evaluated for that Object, and if it qualifies the remaining Request is then possessed for this Object and the result buffered in a result buffer. When completed the top of the Iteration stack is decremented, and the next object in the set or collection is processed. This continues until the element with ordinal number 1 has been processed.
At the end of the iteration the number of qualifying objects is known and the appropriate ‘RES N’ is inserted at the beginning of the result buffer, before this is being returned to the Client-Server.
Conditional Iterative Retrieval Usage
The most important usage of the Conditional Iterative Retrieval request is in the support of the End User Query Language. Statements in the Query Language is compiled into Conditional Iterative Retrieval Request by the Client-Server, and the structured Result returned from the database server is processed according to the Users chosen presentation (html nested Tables, html tables, spreadsheets, word documents or XML). Another significant usage is in the production of pull-down lists for selecting parameter values when evoking a method. The predconditions of methods are provided by the API as boolean functions, and by using a Conditional Iterative Retrieval Request the Client server can request from the database the values of the parameter which would not cause the subsequent evocation to fail. This means that erroneous evocation of methods are kept to a minimum thereby simplifying the need for error handling mechanisms.
v) Operation Codes, Counters and Next
Operation Codes Format

$$\begin{matrix}Attribute\_op :: = & Opcodes \vert \\ & count\_opcode FARG 2 TOK at \text{-} least filter \vert \\ & nextLex\_opcode FARG 2 STR string filter \vert \\ & nextObj\_opcode FARG 2 TOK object filter \vert\end{matrix}$$
Attribute_op can be simple Op_codes, which will retrieve a value in the database (direct or derived), it can Opcodes which will give the size of a subset of any set or object collection in the system, or it can be an opcodes which given an object will determine the next object (in the set or collection) which passes a specific ‘filter’. The order used to find the next object can either be lexicographic on its Identifying label or on the object themselves in case of ordered sets (OSET) where the ordering is determined by the order of insertions. The set of count opcodes and next opcodes are determined by analysis of the data model, and part of the opcodes tables handed to the client-server when the system is configured or re-configured.
   Response::=RES 1 TOK 4 byte
where the 4byte is either a Number (for counters) or an Object Identifier.
The interpretation of standard Opcodes results in a direct call to the database and the data returned from the database is put into the result buffer which is then returned to the Client-Server. A count opcode is handled by iterating through the set in question, using the database primitives to retrieve the objects one by one—the filter is then applied as for Conditional Iterative Requests and if the object qualifies an internal counter is increased. The final value of this counter is returned to the Clientserver. The counting will stop when the number ‘at-least’ is reached.
A next opcode is handled searching through the set or collection of objects for the next object. NextLex will locate a qualifying object which has the lexicographically smallest Identifying Key which also is greater or equal to the string provided. The string provided is assumed to be the Identifying key of a previous object. NextObj will locate the first qualifying object after the object provided as an argument to the operation.
The standard opcodes are used by the Client-Server to extract number values and string values from the database. The Methods file defines what opcodes are available for that purpose: if att1 is a name of an attribute of Natural Number Type, Object Type or Enumerated type, then an operation ‘val_att1’ is used. The actual code for the ‘val_att1’ is defined by the Database generation mechanism and passed to the Client-server during system configuration. If att2 is a string type then an opcode ‘xtr_att2’ is used.
Count, NextLex opcodes are defined for all SETS and Object Collections, while NextObj is defined for Ordered Sets (OSET).
The Count facility is used to support the Query language in implementing Universal and Existential Quantifiers, i.e.
   EQL
      ATT 1 count_set FARG 2 TOK 1 ‘quantified predicate’
      TOK 1
give an efficient implementation of an Existential quantifier, while
   EQL
      ATT 1 count_set FARG 2 TOK max_int ‘quantified predicate’
      ATT 1 card_set
gives the implementation of a Univeral Quantifier over a set.
The next facility is used by the Client-Server to implement the Broser-mechanism which is provided for all collections and sets in the system.
The toolkit provides a rich environment in which specifications can be checked for consistency, designs proved correct, and proof obligations discharged with minimal effort. Should the application demand a higher degree of assurance, the toolkit can be used to construct formal proofs of specific properties.
   3. Incremental Build

The generation process is completely automatic, BOOSTER systems being developed and built incrementally. The starting point for the process is the extraction of a minimal administrator system (from any current BOOSTER system) which provides an archive of a complete BOOSTER development environment, enabling the building of a minimal system comprising the single Access administrator object.

Some of the AMN constructs produced will be common to every build, and so will be generated only once—the first time that the generation process is invoked. Furthermore, the incremental nature of the development process ensures that only those AMN constructs corresponding to objects which have changed are actual generated.

It is worth noting that the configuration manager of the toolkit ensures that only those constructs which have changed since last configured play a role in rebuilding of a system; unchanged constructs are simply discarded. Even if the generator did not feature an incremental build, the toolkit would ensure that only changed constructs would be considered. The incremental build is there purely to ensure that generation time is kept to a minimum.
a) Program Modules
   The method model is then developed using this minimal system as the starting point (objects, attributes or methods being added, removed or changed), each iteration usually giving rise to a new release of the software. The previous model is analysed and compared with the current model by the generator, so that only those objects which change produce fresh output.
   The generation is performed in three stages.
   1. The model is fully expanded:
      built-in methods' preconditions and postconditions expanded
      methods are extended to ensure the data integrity of linked objects
   2. A comparison is then made of the fully expanded model with that of the previous model.
   3. Generation of changed objects
   This incremental style of development ensures that releases occur frequently, enabling rapid customer feedback, and mirrors the way in which large software systems are built. Data is similarly development. For example we are now into release 83 of SSTL, the first occurring in November 1998.
   The time taken for the generation depends on the changes in the current model, and the size of the model. Small systems will take less than a minute, but complex systems like SSTL may take up to 15 minutes.
b) Data Upgrade
   A software release will normally contain several sub-releases. For example the next SSTL release of 83.03, indicates that release 83 contains sub-releases 00 to 03. The upgrading of live data must participate in the incremental style of the software development, and so the data is similarly built in stages, in this case starting with the live data taken from the current release 82.xx.
   An operation in the Maintenance Panel facilitates this extraction of Upgrade Data, and it (tagged with it's release number) would be downloaded into the 93.00 development directory. The first and last developments would then be set through the Data Upgrade interface (83.00 and 83.03 respectively—see FIG. 9), and the upgrade process would iterate through the four stages, with data from the previous stage (apart from the first development) providing the input for the next.
   The process of data upgrade is entirely automatic. However specific data upgrades may require manual input (for example if a single set of objects is to be distributed among several smaller sets). A facility exists for such manual code to participate in the automated update, so that once the code is written, the upgrade will complete without intervention.
   It has been observed that such manual upgrades usually fall into well-defined categories, and it is thought that it will be possible to replace the hand-written code with a (method-like) specification (from which the code would be automatically generated), which would simplify this task.
   After data has been built, it is checked for integrity using the Iztegrity Checking Module produced by the generator.
   An analysis of the expanded models is made (in a similar way to the analysis prior to generation) to automatically determine the nature of the data upgrade, which may be one of three types:
      1. Full upgrade: typically when an attribute or object is added or removed.
      2. Rename upgrade: when one or more attributes are renamed.
      3. Non-data upgrade: when methods, rather than the data, are changed.
   The Upgrade Data comprises both text and binary forms, and for the full upgrade, the former is used (and this would also simplify migration from another database system). An analysis of the current model is first made to identify the data structures required to build new data, and ANSI C source code is generated on an object-by-object basis to first create each object, and then to set string and set attributes of the object. This code is built directly on the Object Layer of the AMN structure (FIG. 8) using make, mod, add and save primitives.
   The current test data is then analysed and stored in a form appropriate to these data structures, the code compiled and executed to produce new data.
   The second form does not require a complete rebuild of the data, but the renamed data must be reflected in Domain Descriptions and in Queries and for this rename the binary form of the data is more appropriate.
   The third form of upgrade does not impact on the data.
      4. User Interface
a) Input to the Script Generator
   Header files from the API and Maintenance software layer (page 12) together with definition files (constant values and so on) are produced for input to the Script Generator. This also includes all opcodes present in the database, for example card_attendees_OP denoting the operation on the database returning the cardinality of the attribute attendees; the same being true for the whole set of basic operations on strings, numbers and sets.
   In order for any of the main systems to work there has to be a data structure built that represents the database model. Code generators, the domain language and the query language all rely on this structure. The information that is used to build the representation is collected from the database by the database connection whenever a new version or build of the database becomes available.
   Currently seven files are collected:
   The. sys
      This contains the full data description of what has been built. All the enumerated sets, objects and their fields and field linkages and all the definitions of the primitive types.
   The Api.mch
      The is an AMN stub that declares all the object operations that have been generated as part of the database and can therefore be called over the database connection. Each operation describes the object or collection it acts on, it's input parameters and output reply.
   ApiMaintenance.mch and ApiLock.mch
      These are MN stubs for operations that maintain the database and collect documents like: maintenanceMemoryUseageData, maintenance-ServerStatisticsData, maintenanceDataUpgradeDataFiles and utilityObject-Description.
   DcrCtx.h
      A header file containing all of the database connection codes, markers and error messages and database statuses. This is not needed to build the model representation because it is primarily concerned with communication.
   Opcodes.h
      A header file containing the entirety of the operations and codes that can be called including how to fetch fields values, the cardinality of a set, the sort key of an object, browsing through sets and getting an object's token and so on.
   The .tlt
      This is the transliteration file. It contains automatically generated transliteration of each objects precondition into natural language, currently just English. This can be used to inform the user of why any of the operations are not applicable. The transliteration of each operation's post condition describes what operation does.
   To create the structure, first lookup tables are created to house the information being brought in so that all can be linked together later on. Look ups are created for bases, base fields, enumerated sets, operations, string types and number types. For each of the lookup tables there is an entity type to represent the entities decoded. For example: Base, BaseField, EnumeratedSet, Operation and so on, and these form the model representation when they are connected together.
   All the files are parsed. Definitions clauses are decoded and yield all the primitive types: strings, numbers and their dimensions, and dates. Default types are created: DATE, MONEY and TIME if they have not already been created. The enumerated sets are decoded. All the bases are then decoded along with their fields and linkages and the operations are decoded from the .h and the .mch files. Each operation in the .mch has input parameters and return values. Finally, the transliteration phases are brought in.
   Now that all the information has been collected and decoded the structure can be linked together. Forming the representation involves the following process. The field linkages are connected—forward and backward links.
   All the fields inspect themselves and produce the calls they can make to the database: requests for information and set field operations. If the field has abase type then they produce a set of ID fields minus any fields already in the base context for the purpose of representing itself to a user.
   Each base then inspects itself and asks whether it is representing an enumeration, contains date fields, has a number in it's ID, has set fields, has non set fields and whether it has a visible presence at all.
   The Question system is checked for and each base then associates Questions with fields. A virtual base is added that contains Idynamic field types such as CURRENTDATE and CURRENTTIME.
   Now the operatins are linked, the objects representing bases and fields and types are substituted for their names in the operation inputs and outputs. Any names not found are set up as virtual fields as these are transient inputs, probably from prompts to the user. The operations then have their collection filters generated.
   Now that the data model representation has been constructed the domain descriptions can be decoded. The generators and the query language need both the domain description and the data model representation to function. For each privilege group, access attributes are given to each field. From this the set of bases, fields and operations that can be seen, navigated to or used to modify can be built.
b) Program Generator
   The generator program iterates over the object model representation and over the domain description for each area that has been recognised as a separate section. The iteration should be done in two passes. The first pass is an information collecting exercise that maps out dependencies and linkages between parts and stores this information globally. The second pass calls program layers that are capable of creating code, although they may not do so immediately they can build a structure that they can refine to code later. Then the code can be asked for, produced and committed to disk. So given a layered structure like the one in 6.1.1 the model can be iterated per layer, future dependencies found and a code structure mapped out. In order for the final code to hang together the code structure produced should take advantage of uniform utilities. Such utilities give power to the whole process and they can include:
   structures that represent packages, classes, methods, scopes, attributes, inheritance
   variable declaration handlers—naming, scoping, non-repetition
   structures that represent templates
      attributes with add, delete, get, set
      programming structures
      produce database request, variables, database reply match and set the variables
      as well as allow code to be added to the structure
      concatenation templates
      variable/conditional switches—code that tests and then follows a route
   data type representation conversion—dates to numbers, dates to strings, defined numbers to numbers, defined numbers to strings text to html, dos and mac to unix etc.
   converting all the representations returned by a request to human readable and vice versa.
   Link later structures—this prevents ‘catch 22’ situations where sections are interdependant.
c) Request Generation
   The client-Server presents all the methods defined in the Method Description as activation buttons on the Clients screens; each screen concerns one Object, its attributes, and its relationships (i.e. set attributes). Each Method which can be used to modify the Object or its relationship to other Objects correspond to a button.
   When a button which corresponds to a method with no inputs is used—a single Operation Request
      OPR 1 opcode 2 Client Object
   is issued; if the Method requires inputs a new panel which allow the end user to enter input is displayed and a (commit) button will cause a single Operation request
      OPR 1 opcode n Client Object arg3 . . . argn
   to be issued.
   If a method is defined on the elements of a set attribute (i.e. on a one-to-many or many-to many object relationship), then a panel which allow the user to select or de-select elements from the set which is presented, and on (Commit) a multiple Operation Request
      OPR N opcode arguments1 . . . opcode argumentN
   If the Client-Server receive a response from a new version of the database—then response is ignored. The Client-Server will instead request from the database all the database definition tables
      OPR 1 SSTL VersionAndFilesRequest_OP
   and use the files returned to update all its internal parser-tables and panel generators, before re-issuing the request.
   Activation Buttons which correspond to methods which in the current state are NOT applicable (outside their precondition) are de-sensitized—and cannot be used. However, as we operate in an interleaved environment, the state of the data might change after the button has been made available, hence there is always the possibility the operation might not be applicable when it is eventually requested.
   Each Panel presented to the Client, contains information which is a result of a Record Retrieval Request.
   The object Description part of the Method Descriptions defines the contents of the Panels presented to the User. When a User navigates to a new object from a link in a Panel then a new Record Retrieval Request is issued; the resulting data constitutes the dynamically changing contents of the next panel represented to the user. All the scripts for retrieving this information and presenting the information is generated on configuration time, using the tables produced from the Method Description by the database generators.
      5. Query Language

Since booster carries with it the advantages of implementation abstraction for developers and non-developers alike, and utilises object oriented navigation, it is natural to expect there is a query language that can harness the benefits and convenience that this approach to databases brings. The implementation has been abstracted from view so we can unleash the potential for non-developers to use it hands on. The navigational properties of the database completely erase the need for user-unfriendly table joins in the query language. With the description of the data model in front of them, users can construct queries to extract the information they need.

Security is, as always, a major issue when people are allowed to extract information. How are query writers prevented from writing a query that will return sensitive information. The answer is that the query language uses the domain description. The domain description applies just as fully in this context as it does in anywhere else for this database design. A user within a particular privilege group cannot see or navigate to anywhere outside the cordoned area defined by the domain description.

Query languages, historically, tend towards a natural language form of expression. A query can be read out loud to someone else without too much confusion. In order to not re-invent the wheel but to upgrade the wheel so that it is safe for non-developers to drive, the booster database query language takes some elements and ideas from the common place SQL: The keywords FROM, SELECT, WHERE. Because we can navigate we can also easily allow a structured query so we need the keyword END to end any statement. SQL is interested in joining together tables to make more tables. Booster query language is interested in navigating through the data model and returning a section of the model with the structure intact. SQL expects that query writers will join several tables together to construct sets. The booster query language has sets built into the data model and therefore does not need to construct them nor does it need tables to represent the sets themselves.

[image]

[image]

[image]

6. Documentation

a) Design Documentation
   Two html versions of the method file are produced, one showing the data without the methods, the Object Description, and one including the methods, the Method Description, both indexed and fully navigable—especially between linked objects. The unexpanded versions of the methods is provided (because of space considerations).
   These documents exist not only for the interested user but also to aid the creation of database Queries and the construction of Domains Descriptions.
b) User Documentation
   Because these documents are always produced at the same time as everything else, and are automatically packaged by the B-Toolkit, documentation is always guaranteed to be consistent with respect to the specification and other parts of the system—it can never be out of date!
c) On-line Help.
   This document provides a natural language description of method preconditions, the purpose being that when an interface operation is inapplicable and explanation is immediately available through the mouse. It is anticipated that this will also be extended to postconditions.
      7. Access control

Given an object oriented data model and a set of users how can you control what they can and cannot see or do. This is the problem solved by the domain description language.

The domain language builds on the key idea of each object having a state that is comprised by the data contained by that object. [diagram of object instances with field values]

The state of any object is changed by modifying the data stored in any of it's fields. Any operation that changes the state of it's object can be linked directly to what fields are changed. On these grounds you can define what is permissible by marking individual fields of an object with access attributes.

There are four of these attributes. The first two are the most obvious, they are called invisible and viewability. These are whether the field can be seen. I have mentioned operations that change a field's value. From this comes the third attribute ‘modifiability’. Since we wish to preserve the object oriented nature of the data model we have a fourth access attribute: clickability. Clickability is someone's ability to navigate from one object to another via a field.

It is paramount for security that users are placed into groups by their role as a database user. So for each group of user you can define a domain that bounds that group to seeing, modifying and finding a particular subset of the whole system. This differs greatly from the usual approach which expects the developer to build forms and operations for each group whereas using a domain the developer is given all the operations and has to narrow down the privileges. This is much quicker, easier and safer. Privileges can be given and revoked, groups created, users moved from group to group whilst the system is running and no-one has to write any code for it.

Any object operation's availability for use within a domain can be determined by whether the changes the operation makes are allowed. If all the fields that an operation changes are modifiable then the operation is permitted. It may well be the case that some operations should be disallowed outright. In this case an operation can be made invisible so as not to show up or completely omitted in which case it is expressly forbidden for that operation to be done on behalf of this domain group or even for code to be generated that could activate it.

A domain description also describes a privilege groups mode of entry into a database, listing the collections available to select from and entry points that can be navigated to from an individual user's Access object.

So far it is possible to describe any user's entry into the database, where they can get to, what they can see and what they can do but this description up to now will only produce a ‘static’ control for a domain: there is no account taken for the current state of the data. Domains are actually dynamic. It is possible to give a predicate for each of the access attributes that will make the access applicable or not. For instance, a field may be provided which is clickable before a certain time or modifiable if there is a certain state. This works for set fields too. There are even cases where it may be desired for the view of the same object to be different to members of the same access group. Take the example of personal information. A user might always be permitted to see their own but may only see someone else's name and picture.

A collection of mechanisms and novel description languages have been described above for the automatic generation of software applications. The applications generated may be characterised as information systems, or database systems, complete with user interfaces. More specifically, they maybe characterised as secure, navigable, object databases.

The nature of the description language, and the design of the mechanisms, means that the behaviour of the systems may be formally guaranteed: a proof, in terms of mathematical logic can be presented to show that each system will behave in accordance with the original description. This has practical value, as the descriptions are sufficiently abstract, and readable, to be used in requirements analysis.

The generated implementation of each system is optimal, in the sense that no functionality is generated, at the application's programming interface, unless it is required by the original description. The generation process produces a system exactly customised to the formal abstract statement of requirements.

Two complementary mechanisms are also described: the first of these supports incremental development, allowing for the automatic, parameterised comparison between different descriptions of the same system; the second provides an additional level of integrity checking for data in generated systems.

Thus, there are a number of significant advantages associated with the above-described system and method:
1. Correctness of Design—the use of an object-oriented modelling language means that the design of the system is more easily related to objects in the real world: it is far easier to capture the requirements upon a web-based information system in terms of classes of objects and operations upon them, than in terms of keys and tables. The difficult process of requirements elicitation and system specification is simplified further by the fact that the system itself can be treated as a rapid prototype. As soon as a model has been built, it can be compiled to produce a working system; if the design subsequently seems unacceptable, it can then be revised. Because this prototype is actually a final implementation, it can run with live data while the design process continues: an important benefit for users or customers, who have access to a working system almost immediately, as well as to the designers, who can validate their design with users and live data.
2. Correctness of Implementation—the fact that the database code is generated from the model means that the correctness of the implementation, with respect to the model, can be guaranteed. The same is true for the communications protocol (the token language), the query language and the scripts that are read by the web-server.
3. Maintenance—simple utilities are provided to extract and reload the sum of data that is held in the database. This means that any change to the model, whether this stems from a changing perception of needs or an error in the current design, can be implemented substantially immediately. The process of extracting and reloading is extremely fast, and the web-server can continue to operate while it is taking place. Any queries will be held and passed to the new database, Another advantage of the basic solution architecture is the lack of any handwritten web pages. Because the behaviour of the web server is based entirely on the structure of the generated database, there are no pages of HTML (or anything else) to update.
4. Performance—the solution architecture provides a well-defined separation between components: this in itself allows users to take advantage of hardware and software improvements wherever they occur. The number of web servers can be multiplied to meet demand. Further, data management is optimal, and there is no redundancy of code or features. Instead of a generic database engine interpreting a model, there is a single compiled customised database program.
5. Security—access to the information in the database is controlled by the domain specification, which is both concise and formal. Security can also be addressed with the system model: the degree of user authentication and checking at the interface to the database can be arbitrarily increased.

It should be noted that the above-mentioned embodiment illustrates rather than limits the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A method for use in generating an information system, the method comprising the steps of:
a) providing an object-oriented model of said information system defining classes of information objects required to be supported by said information system in terms of their attributes, operations that may be performed on said objects, and an intended relationship (if any) between two or more of said objects;
b) providing built-in or predefined descriptions of operations which may be performed on said objects, in terms of conditions that should hold initially, data that might be affected, and the desired results;
c) automatically expanding an operation referenced in a class definition by adding a respective built-in or predefined description thereto within said object-oriented model of said information system;
d) determining if the attributes of any other class defined within said model would be affected by said operation and, if so:
e) automatically further expanding said operation to include an update function to update one or more attributes determined to be affected by said operation accordingly.

2. A method according to claim 1, wherein said attributes are declared in said object-oriented model of said information system as elements of a particular type.

3. A method according to claim 1 or claim 2, wherein an additional feature is defined in respect of said attributes and classes, said additional feature comprising a dimension which is the expected average length of a string or the cardinality of a set.

4. A method according to any one of claims 1 to 3, wherein a user is able to define enumerated types and/or type synonyms.

5. A method according to any one of claims 1 to 4, wherein one or more of said attributes may be of object type which describe references to objects in the same environment.

6. A method according to claim 5, wherein links are provided between two or more of said references, said links implementing relationships between respective references.

7. A method according to claim 6, wherein relationships implemented by said links may be one-to-one, one-to-many, many-to-one or many-to-many.

8. A method according to any one of the preceding claims, wherein the behaviour of a particular class of objects is described by a collection of method definitions.

9. A method according to claim 8, wherein said method definitions may be classed in terms of operations which are to be accessible to a user and operations which are only to be used in the definition of other methods.

10. A method according to claim 8 or claim 9, wherein a method can be defined in the context of a particular attribute.

11. A method according to any one of claims 8 to 10, wherein a method maybe described in an abstract manner in terms of properties.

12. A method according to any one of the preceding claims, wherein every method or operation is defined as a combination of two properties, a precondition and a postcondition, together with a list of attributes whose values might change.

13. A method according to claim 12, wherein if an attribute is included in said list but not in said postcondition, said attribute will appear as an input to the respective operation, and is assigned a default postcondition specifying that the value of such an attribute after said operation will be equal to the value of the input provided.

14. A method for use in generating an information system, the method being substantially as herein described with reference to the accompanying drawings.

15. Apparatus for use in generating an information system, the apparatus comprising:
a) means for providing an object-oriented model of said information system defining classes of information objects required to be supported by said information system in terms of their attributes, operations that may be performed on said objects, and an intended relationship (if any) between two or more of said objects;
b) means for providing built-in or predefined descriptions of operations which may be performed on said objects, in terms of conditions that should hold initially, data that might be affected, and the desired results;
c) means for automatically expanding an operation referenced in a class definition by adding a respective built-in or predefined description thereto within said object-oriented model of said information system;
d) means for determining if the attributes of any other class defined within said model would be affected by said operation and, if so, automatically further expanding said operation to include an update function to update one or more attributes determined to be affected by said operation accordingly.

16. Apparatus according to claim 15, wherein one or more of said attributes point to a data item stored on a server which may be separate from or integral with said apparatus.

17. Apparatus according to claim 15 or claim 16, further including means for performing any of the steps or implementing any of the features of a method according to any one of claims 1 to 13.

18. Apparatus for use in generating an information system, the apparatus being substantially as herein described with reference to the accompanying drawings.

19. Apparatus for use in generating an information system, the apparatus comprising:
a) means for generating a first object-oriented model of said information system;
b) means for generating a second object-oriented model of said information system;
c) means for comparing said first and second models and identifying any differences therebetween; and
d) means for automatically generating only the objects which have changed between said first and second models.

20. Apparatus according to claim 19, further including means for automatically upgrading any test data used in said first model to reflect changes made between said first and second models, such that said test data is in a correct form for use in said second model.

21. Apparatus according to claim 19 or claim 20, including apparatus according to any one of claims 15 to 17.

22. A method for use in generating an information system, the method comprising the steps of:
a) generating a first object-oriented model of said information system;
b) generating a second object-oriented model of said information system;
c) comparing said first and second models and identifying any differences therebetween; and
d) automatically generating only the objects which have changed between the first and second models.

23. A method according to claim 22, further including the step of automatically upgrading any test data used in said first model to reflect changes made between said first and second models, such that said test data is in a correct form for use in said second model.

24. A method according to claim 22 or claim 23, including the steps or features of a method according to any one of claims 1 to 13.
